(19) United States
(12) Patent Application Publication
(10) Pub. No.: US 2008/0245960 A1
(43) Pub. Date: Oct. 9, 2008

(54) Method and Apparatus to Determine Characteristics of an Oil-Based Mud Downhole

(75) Inventor: Sebastian CSUTAK, Houston, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/697,892

(22) Filed: Apr. 9, 2007

(51) Int. Cl. G01V 5/08; G01N 21/35

(52) U.S. Cl. 250/269.1; 250/339.12

(57) ABSTRACT

A laser spectroscopy system can determine the identity and/or quantity of a component of a fluid at a remote location such as downhole in a wellbore or inside a pipeline, particularly at high temperature, e.g. from about 75 to 175° C. The system includes a fiber laser doped with a rare earth element (e.g. Nd³⁺, Tm³⁺, Er³⁺, Th³⁺, Ho³⁺, Yb³⁺, Pr³⁺) and generates light in a wavelength between about 900 to about 3000 nm. The system may analyze a drilling mud such as an oil based mud or crude oil, and may detect components such as methane, ethane, carbon dioxide, hydrogen sulfide and the like.

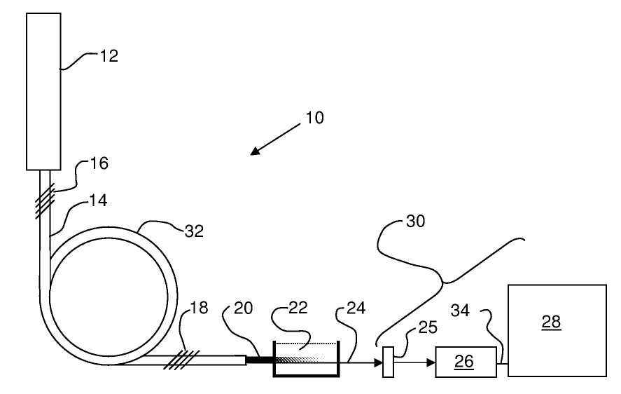

### TECHNICAL FIELD

The invention relates to apparatus and methods for determining the composition of liquid samples at remote locations, and most particularly relates, in one non-limiting embodiment, to apparatus and methods for determining the composition of liquid samples at high temperatures at remote locations, such as wellbores and pipelines.

### BACKGROUND

A variety of techniques have been utilized for monitoring wellbores and liquids therein during completion and production of wellbores, analyzing reservoir conditions, estimating quantities of hydrocarbons (oil and gas), operating downhole devices in the wellbores, and determining the physical condition of the wellbore and downhole devices.

Reservoir monitoring typically involves determining certain downhole parameters in producing wellbores at various locations in one or more producing wellbores in a field, typically over extended time periods. Wireline tools are most commonly utilized to obtain such measurements, which involves transporting the wireline tools to the wellsite, conveying the tools into the wellbores, shutting down the production and making measurements over extended periods of time and processing the resultant data at the surface. The wireline methods are utilized at relatively large time intervals, and thus do not provide continuous information about the wellbore condition or that of the surrounding formations.

It is also possible to measure formation properties during the excavation of the hole, or shortly thereafter, by using tools integrated into the bottomhole assembly through a technique called logging while drilling (LWD). This method may be risky and expensive, yet it has the advantage of measuring properties of a formation before drilling fluids invade deeply. Further, many wellbores prove to be difficult or even impossible to measure with conventional wireline tools, particularly highly deviated wells. In these situations, a LWD measurement ensures that some measurement of the subsurface is captured in case wireline operations are not possible.

A commonly used drilling fluid or drill-in fluid is oil based mud (OBM). OBM in the context herein should be understood to include synthetic-based mud (SBM), where synthetic, non-aqueous liquids are part of the base fluid. The other commonly used drilling fluid type is water-based mud or WBM.

Spectroscopy is a known technique for characterizing drilling muds and crude oil. For instance, methods are known for analyzing drilling muds that involve reflectance or transmittance infrared spectroscopy. However, such methods may rely on a calibration set of well-characterized materials, which may or may not correspond to materials in field use, and may have very limited accuracy for the mineralogy estimates, with no indication of the accuracy of the other estimates.

Methods are also known for analyzing the chemistry of drilling fluids, as well as the concentrations of tracers in these fluids. Such methods claim the ability to measure the presence of a hydrocarbon of interest in the drilling fluid, presence of water in the drilling fluid, amount of solids in the drilling fluid, density of the drilling fluid, composition of the drilling fluid downhole, pH of the drilling fluid, and presence of H₂S or CO₂ in the drilling fluid. These measurements are obtained using optical spectroscopy alone, reflectance/transmittance alone, and optical spectroscopy combined with sol/gel technology to provide a medium for reactions of chemicals in the mud with chemicals in the glass to provide color centers that can be detected optically. The chemicals in the mud can be added as part of the mud program or can be present as the result of influx from the formations being drilled. A micro-scale grating light reflection spectroscopy probe may also be for use as used as a process monitor.

There is a need in the art for a convenient method of continuous or intermittent measurement and analysis of drilling fluid chemicals or crude oils. Deficiencies in the drilling fluid or the presence of influxes could be detected in real-time, potential well control or hazardous situations could be avoided, appropriate treatment could be applied, costly mud-related delays could be averted, and expensive production shut downs minimized. Such a system could more efficiently address drilling fluid chemistry problems relating to drilling fluid flocculation and chemical imbalances and hazardous influxes of H₂S, CO₂, and CH₄. In addition, the method could also provide valuable measurements of hydrocarbon gases, noxious gases, crude oil, water, tracers, and inhibitor (scale and asphaltene deposition, hydrate formation) concentrations.

Spectroscopy is a very powerful tool for determining the composition of chemical samples. Laser spectroscopy may be successfully used to identify different components of live crude oils, such as H₂S, CO₂, and CH₄, alkenes and aromatics. (Live oil generally refers to crude oil still having solution gases present therein.) However, spectroscopy systems that can operate at the high temperatures downhole are unknown.

### SUMMARY

There is provided, in one non-limiting form, a fluid characterization system that includes a pump laser optically connected to a fiber laser, both of which are at a remote location. The remote location is one that is inaccessible or difficult to physically reach or contact, such as downhole in a wellbore or inside a pipeline. The fiber laser includes a fiber doped with a rare earth element; it is capable of generating light in a wavelength between about 900 to about 3000 nm. A fluid (such as a drilling mud, crude oil, or mixture thereof) absorbs a part of the light and transmits a remainder of the light. A spectroscopy apparatus includes wavelength selection device (e.g. one or more diffraction grating, one or more filter, e.g. a Fabry-Perot filter, a thin film filter, or the like, and combinations thereof), a photodetector that receives the remainder of the light, and an analyzer that filters the signal that arrives to the photodetector and characterizes at least one component or property of the fluid by determining the wavelength of the light absorbed by the fluid.

There is also provided, in another non-restrictive embodiment, a method for characterizing a fluid at a remote location through a conduit. The method includes generating laser light at the remote location having a wavelength between about 900 to about 3000 nm into a fluid. A fiber doped with a rare earth element generates the laser light. The method further involves absorbing a part of the light in a fluid and transmitting a remainder of the light through the fluid. Further the method includes detecting the remainder of the light in a spectroscopy apparatus, and characterizing at least one component or property of the fluid by determining the wavelength of the light absorbed by the fluid using the spectroscopy apparatus.

### BRIEF DESCRIPTION OF THE DRAWING

The Figure is a schematic illustration of one non-limiting embodiment of the fluid characterization system herein.

### DETAILED DESCRIPTION

As noted, there is a difficulty in conducting measurements downhole, such as to determine the type and/or quantity of certain components, at relatively high temperatures using a laser source in the spectral region of interest of 900-3000 nm (near infrared). Short wavelength lasers in the 500-1000 nm range are much easier to operate at well temperatures, typically from about 75 to about 175° C., but longer wavelength lasers that may function at this temperature have limited output optical power. It has been discovered that this problem may be resolved by using a fiber laser where the fiber is doped with a rare earth element such as erbium (Er³⁺), thulium (Tm³⁺), thorium (Th³⁺), and the like.

Fiber lasers are nearly always based on glass fibers which may be doped with laser-active rare earth ions, generally present only in the fiber core. The ions absorb pump light, typically at a shorter wavelength than the laser or amplifier wavelength, which excites them into some metastable electronic state. This allows for light amplification via stimulated emission. They are a gain media with a particularly high gain efficiency, resulting mainly from the high optical confinement in the fiber's waveguide structure. In the case of rare earth doped silica fibers, the core composition is often modified with additional dopants, giving e.g. aluminosilicate, germanosilicate or phosphosilicate glass, or the like. Such codopants often improve the solubility of rare earth doping concentration without quenching of the upper state lifetime.

The invention may be schematically illustrated in the FIGURE where the overall fluid characterization system is designated at 10 and the pump laser 12 is optically connected to a fiber laser 32 doped with the rare earth element. The laser cavity 14 of fiber laser 32 is defined by two mirrors formed by fiber Bragg gratings 16 and 18. The laser light 20 having a wavelength between about 900 to about 3000 nm exits the fiber laser into a fluid sample 22. Part of the light 20 is absorbed by the fluid 22, and the remainder 24 of the light filtered by a wavelength analyzer 25 then received by photodetector 26 of spectroscopy apparatus 30. Photodetector 26 sends a signal 34 to an analyzer 28 for characterizing a property of the fluid 22 or the type and/or quantity of a particular component. The wavelength selection device or analyzer 25 involves source-sample-filtering (wavelength selection) method-detection-post processing and may include one or more diffraction grating, a Fabry-Perot filter, a thin film filter, or combinations thereof.

Pump laser 12 may be one that can provide laser light in the range of about 750 to about 1000 nm. It should, of course, be able to withstand a temperature in the range of from about ambient up to about 75 to about 175° C., that is, the temperature of the environment of the fluid of interest. Such pump lasers are generally not tolerant of high temperatures, but some are becoming available. Suitable pump lasers include, but are not necessarily limited to, JDSU 5800 series Datalink InGaAs lasers (available from JDS Uniphase Corporation), Bookham LU9**X 980 nm pump lasers, and the like. Since the fiber laser 32 is generally flexible, the pump laser 12 may be rigid and may be oriented with its axis parallel to the axis of the conduit in which it is placed. Suitable pumps for the fiber laser may include, but are not limited to, GaAs-based, GaP-based, GaN-based, or AlAs-based, semiconductor lasers that are readily commercially available, or another available semiconductor laser diode.

The pump laser 12 is optically connected to fiber laser 32, which is flexible and may be coiled to save space. The fiber laser 32 contains a laser cavity 14 between two mirrors, generally diffraction gratings 16 and 18. The laser cavity 14 may be between about tens of centimeters to about 5 meters long depending on the amount of rare earth material that exists in the fiber. Because they are flexible and may be coiled to save space, fiber lasers may have extremely long gain regions. They can also support very high output powers (e.g. tens of milliwatts up to around 100 mW) because of the fiber's high surface area to volume ratio allows efficient cooling, and its wave guiding properties reduce thermal distortion of the beam. The fiber laser 32 and laser cavity 14 may be double-cladded, and may have a diameter (not including the outermost cladding where light does not travel) of between about 10 to about 200 microns. In double-clad fibers, the gain medium forms the core of the fiber, which is surrounded by two layers of cladding. The lasing mode propagates in the core, while a multimode pump beam propagates in the inner cladding layer. The outer cladding keeps the pump light confined. This design permits the core to be pumped with a much higher power beam than could otherwise be made to propagate in it, and thus allows the conversion of pump light with relatively low brightness into a much higher brightness signal. Double-clad fibers can also be made as photonic crystal fibers. Here, the inner cladding is surrounded by large air holes and can thus have a very high numerical aperture. This further reduces the requirements concerning the brightness of the pump source.

The length of the mirrors 16 and 18 themselves may be from about 1 to about 5 mm, even up to about 1 cm in length. The fiber laser 32 should have good confinement to operate efficiently. By judicious choice of the core and the first cladding around the core, confinement may be optimized. Better confined fibers will give better lasing efficiency and help the most at high temperatures. Fiber Bragg gratings (FBG) may be employed. Such gratings have annealing characteristics similar to type II damage fiber gratings and may demonstrate stable operation at temperatures as high as 950° C. or even 1000° C. For silica-based fibers, temperatures on the order of 1050° C. for prolonged periods may cause grating erasure. Such grating devices exhibit low polarization dependence, and the primary mechanism of induced index change results from a structural modification to the fiber core. FBGs are expected to be an economical way to write ultrastable gratings of good spectral quality. Highly reflective Bragg ratings may be produced by direct point-to-point writing with an infrared femtosecond laser. Special coatings are not needed. Photonic crystal fibers may also be employed to help provide fiber lasers useful at high temperatures. Photonic crystals are periodic optical nanostructures that are designed to affect the motion of photons in a similar way that periodicity of a semiconductor crystal affects the motion of electrons. Holley fibers are also expected to be particularly useful.

The diffraction gratings 16 and 18 are made by changing the refractive index of the media in making a periodic structure. They may be made by direct etching and/or by gentle ultraviolet (UV) exposure. There are several methods in which the fiber cladding may be stripped and the grating inscribed by etching periodic grooves into the core of the fiber.

Suitable rare earth elements for doping the fiber laser 32 include, but are not necessarily limited to erbium (Er³⁺), thulium (Tm³⁺), thorium (Th³⁺), holmium (Ho³⁺), ytterbium (Yb³⁺) praseodymium (Pr³⁺), neodymium (Nd³⁺), combinations thereof, and the like. Generally, the fiber laser should be doped with as much as possible of the particular rare earth element, but it is recognized that there are upper limits to doping. Rare earth-doped fiber lasers are known to be useful in sensing hydrocarbons. For instance, Tm³⁺-doped fiber lasers are known to be useful in sensing methane, and are known to be compact and efficient. Fiber lasers may be tuned to particular absorption lines by rotating the diffraction gratings and monitoring the change in light intensity transmitted by a hydrocarbon (e.g. CH₄) bearing gas cell until a maximum attenuation is obtained. This helps eliminate cross-sensitivity to other gases.

The doped fibers may be silica fibers, but may also be other types such as fluorozirconate or ZBLAN fibers (Zr, Ba, La, Al, Na—heavy metal fluoride glasses). Other types of optical fibers, such as photonic crystals, may also be employed in the methods and apparatus herein to advantage. In non-limiting examples, fibers with air holes running down their length may be considered for making fiber lasers with FBGs. The mode areas for pump and signal in these fiber lasers may be either larger or smaller compared to the corresponding mode areas for fiber lasers based on standard step index fibers. Here, larger mode areas would provide high power.

The fluid characterization system 10 may contain more than one fiber laser 32. Further, the signal from several lasers may be optionally combined using a coupler. At certain wavelengths, certain compounds of interest absorb the laser light, e.g. CH₄, H₂S, etc. Thus, in some non-restrictive embodiments, the system 10 may have a separate fiber laser 32 for each species of interest. The fluid characterization system described herein may thus be used to characterize the gas/oil ratio (GOR) potential of the live oil downhole. Alternatively, the system herein may be used to examine OBMs or other muds (e.g. SBM) and fluids to determine if either a SBM or a crude oil is present when it is not wanted. For instance, crude oil may contain certain olefins or alkenes, but not esters, whereas SBMs typically contain esters. Certain components may serve as markers for certain fluids.

The spectroscopy apparatus, such as 30, may be conventional, the photodetector 26 may be any suitable device including, but not necessarily limited to a photodiode or an array of photodiodes, a charge coupled device (CCD), complementary metal oxide semiconductor (CMOS) sensor, and the like. Filters may be used that are on the order of 10 nm wide or less. Fabry-Perot filters are one kind that may be used to select a specific lasing mode. The laser may have a much narrower line width, on the order of 0.05 nm. The analyzer 28 may be any suitable, conventional or yet to be develop spectrometer, spectroscope or the like that can take an absorption spectrum and determine the identity and/or quantity of one or more chemical species. The amount absorbed by the sample 22, i.e. the amount of absorption at a given wavelength gives the quantitative analysis. Several lasers may be used to measure or detect different compounds, each laser with its own photodetector. This technique may give higher resolution for each species of interest.

The methods and apparatus herein may thus be used to detect deficiencies in the drilling fluid or the presence of influxes in real-time, and potential well control or hazardous situations could be avoided or prevented. Appropriate treatment could be applied, costly mud-related delays could be averted, and expensive production shut downs minimized. These systems and methods could more efficiently address drilling fluid chemistry problems relating to drilling fluid flocculation and chemical imbalances, and hazardous influxes of H₂S, CO₂, CH₄, and C₂H₆ and the like, “on-the-fly”. In addition, the methods and systems herein may also provide valuable measurements of hydrocarbon gases, noxious gases, crude oil, water, tracers, alkenes, aromatics, and inhibitor (scale and asphaltene deposition, hydrate formation) concentrations. For the purposes of the methods and apparatus herein, naphthalene and naphthenic compounds are considered aromatic.

Many modifications may be made in the methods, apparatus, and systems described herein without departing from the spirit and scope thereof that are defined only in the appended claims. For example, the fiber laser may be doped differently than described, or the pairing of the pump laser and fiber laser may be other than what has been outlined as non-limiting examples. Additionally, the methods and apparatus described are also expected to find use in different environments than hydrocarbon wells, pipelines, and the like.

Further, the word “comprising” as used throughout the claims, is to be interpreted to mean “including but not limited to”. Similarly, the word “comprises” as used throughout the claims, is to be interpreted to mean “includes but not limited to”.

1. A fluid characterization system comprising:
a pump laser optically connected to a fiber laser, both at a remote location, where a fiber of the fiber laser is doped with a rare earth element and the fiber laser is capable of generating light in a wavelength between about 900 to about 3000 nm;
a spectroscopy apparatus configured to receive a remainder of the light not absorbed by a fluid, the apparatus comprising:
a wavelength selection device selected from the group consisting of at least one diffraction grating, a filter, and combinations thereof;
a photodetector; and
an analyzer that receives a signal from the photodetector and configured to characterize at least one component or property of the fluid by determining the wavelength of the light absorbed by the fluid;
where the system can withstand a temperature in the range of from about 75 to about 175° C.

2. (canceled)

3. The fluid characterization system of claim 1 where the rare earth element is selected from the group consisting of neodymium, thulium, erbium, thorium, holmium, ytterbium, praseodymium, and combinations thereof.

4. The fluid characterization system of claim 1 where the component is selected from the group consisting of methane, ethane, hydrogen sulfide, carbon dioxide, alkene compounds, aromatic compounds and combinations thereof.

5. The fluid characterization system of claim 1 where the fiber laser comprises a structure selected from the group consisting of:
two fiber Bragg gratings on either side of a lasing cavity;
directly etched gratings;
double-clad or single-clad confined fiber;
photonic crystal fiber; and
combinations thereof.

6. The fluid characterization system of claim 1 where the remote location is downhole in a wellbore.

7. The fluid characterization system of claim 1 where the remote location is in a pipeline.

8. The fluid characterization system of claim 1 where the spectroscopy apparatus further comprises a spectrometer.

9. The fluid characterization system of claim 1 further comprising more than one fiber laser, where each laser is used to characterize a different component from the other.

10. A fluid characterization system comprising:
a pump laser optically connected to a fiber laser, both at a remote location which is at a temperature in the range of about 75 to about 175° C., where a fiber of the fiber laser is doped with a rare earth element selected from the group consisting of thulium, erbium, thorium, neodymium, holmium, ytterbium, praseodymium, and combinations thereof, and the fiber laser is capable of generating light in a wavelength between about 900 to about 3000 nm, where the fiber laser comprises a structure selected from the group consisting of:
two fiber Bragg gratings on either side of a lasing cavity;
directly etched gratings;
double-clad or single-clad confined fiber;
photonic crystal fiber; and
combinations thereof;
a spectroscopy apparatus configured to receive a remainder of the light not absorbed by a fluid, the apparatus comprising:
a wavelength selection device selected from the group consisting of at least one diffraction grating, a filter, and combinations thereof;
a photodetector; and
an analyzer that receives a signal from the photodetector and configured to characterize at least one component or property of the fluid by determining the wavelength of the light absorbed by the fluid.

11. The fluid characterization system of claim 10 where the component is selected from the group consisting of methane, ethane, hydrogen sulfide, carbon dioxide, alkene compounds, aromatic compounds and combinations thereof.

12. The fluid characterization system of claim 10 where the remote location is downhole in a wellbore.

13. The fluid characterization system of claim 10 where the remote location is in a pipeline.

14. A method for characterizing a fluid at a remote location comprising:
generating laser light at the remote location, where the laser light has a wavelength between about 900 to about 3000 nm and is generated by a fiber doped with a rare earth element;
absorbing a part of the light into a fluid and transmitting a remainder of the light through the fluid;
detecting the remainder of the light in a spectroscopy apparatus; and
characterizing at least one component or property of the fluid by determining the wavelength of the light absorbed by the fluid using the spectroscopy apparatus;
all conducted at a temperature in the range of about 75 to about 175° C.

15. (canceled)

16. The method of claim 14 where the rare earth element is selected from the group consisting of neodymium, thulium, erbium, thorium, holmium, ytterbium, praseodymium, and combinations thereof.

17. The method of claim 14 where the characterizing further comprises identifying and/or quantifying a compound selected from the group consisting of methane, ethane, hydrogen sulfide, carbon dioxide, alkene compounds, aromatic compounds and combinations thereof.

18. The method of claim 14 where the fiber laser comprises a structure selected from the group consisting of:
two fiber Bragg gratings on either side of a lasing cavity;
directly etched gratings;
double-clad or single-clad confined fiber;
photonic crystal fiber; and
combinations thereof.

19. The method of claim 14 where the remote location is downhole where the conduit is a wellbore.

20. The method of claim 14 where the conduit is a pipeline.

21. The method of claim 14 where the spectroscopy apparatus further comprises a spectrometer.

22. The method of claim 14 further comprising more than one fiber laser, where each laser is used to characterize a different component from the other.

23. The method of claim 14 where the fluid is selected from the group consisting of oil based mud, crude oil, and mixtures thereof.

24. A method for characterizing a fluid at a remote location comprising:
generating laser light at the remote location, where the remote location is at a temperature in the range of about 75 to about 175° C., the laser light having a wavelength between about 900 to about 3000 nm, where a fiber doped with a rare earth element selected from the group consisting of thulium, erbium, thorium, neodymium, holmium, ytterbium, praseodymium, and combinations thereof generates the laser light, where the fiber laser comprises a structure selected from the group consisting of:
two fiber Bragg gratings on either side of a lasing cavity;
directly etched gratings;
double-clad or single-clad confined fiber;
photonic crystal fiber; and
combinations thereof;
absorbing a part of the light in a fluid and transmitting a remainder of the light through the fluid;
detecting the remainder of the light in a spectroscopy apparatus; and
characterizing at least one component or property of the fluid by determining the wavelength of the light absorbed by the fluid using the spectroscopy apparatus.

25. The method of claim 24 where the characterizing further comprises identifying and/or quantifying a compound selected from the group consisting of methane, ethane, hydrogen sulfide, carbon dioxide, alkene compounds, aromatic compounds and combinations thereof.

26. The method of claim 24 where the remote location is downhole where the conduit is a wellbore.

27. The method of claim 24 where the conduit is a pipeline.
